(19) United States
(12) Patent Application Publication
(10) Pub. No.: US 2026/0296078 A1
(43) Pub. Date: Oct. 1, 2026

(54) INK RIBBON CARTRIDGE

(71) Applicant: SEIKO EPSON CORPORATION, Tokyo (JP)

(72) Inventors: Kenji MOTAI, Matsumoto-shi (JP); Hibiki AOYAMA, Matsumoto-shi (JP)

(73) Assignee: SEIKO EPSON CORPORATION, Tokyo (JP)

(21) Appl. No.: 19/578,177

(22) Filed: Mar. 25, 2026

(30) Foreign Application Priority Data
Mar. 26, 2025 (JP) 2025-051230

(51) Int. Cl. B41J 32/00; B41J 33/06

(52) U.S. Cl. CPC B41J 32/00; B41J 33/06

(57) ABSTRACT

An ink ribbon cartridge includes: an ink ribbon housing area that is in a cartridge case and is configured to house an ink ribbon; a head insertion hole through which a head of printing apparatus can be inserted at a printing position in cartridge case; an introduction port for introducing a tubular print medium into cartridge case; a medium transport path that connects at least introduction port and printing position, and through which tubular print medium introduced from introduction port is transported to printing position; and movable portion that opens and closes medium transport path from a side of an insertion direction wherein head is inserted, and movable portion includes a restricting portion that restricts movement of tubular print medium in a restriction direction including a component in first direction that intersects a transport direction of tubular print medium in medium transport path and insertion direction of head insertion hole.

The present application is based on, and claims priority from JP Application Serial Number 2025-051230, filed Mar. 26, 2025, the disclosure of which is hereby incorporated by reference herein in its entirety.

### BACKGROUND

### 1. Technical Field

The present disclosure relates to an ink ribbon cartridge.

### 2. Related Art

For example, JP-A-2021-66097 discloses a printing apparatus that performs printing on a tubular print medium by heating in a state where an ink ribbon housed in a cartridge case of an ink ribbon cartridge is pinched together with the tubular print medium between a head and a platen roller. In such an ink ribbon cartridge, it is possible to set the tubular print medium by performing an operation of inserting the tubular print medium into a medium transport path from an introduction port provided in the cartridge case.

However, in such an ink ribbon cartridge, to set the tubular print medium, it is necessary to perform an operation of inserting the tubular print medium into the medium transport path from the introduction port. Therefore, it is desired to improve convenience.

### SUMMARY

According to an aspect of the present disclosure, an ink ribbon cartridge to solve the above issue is an ink ribbon cartridge configured to be mounted on a printing apparatus that performs printing on a tubular print medium that can be introduced from the outside, the ink ribbon cartridge including: an ink ribbon housing area that is in a cartridge case and is configured to house an ink ribbon; a head insertion hole through which a head of the printing apparatus can be inserted at a printing position in the cartridge case; an introduction port for introducing a tubular print medium into the cartridge case; a medium transport path that connects at least the introduction port and the printing position, and through which the tubular print medium introduced from the introduction port is transported to the printing position; and a movable portion that opens and closes the medium transport path from a side of an insertion direction in which the head is inserted, in which the movable portion includes a restricting portion that restricts movement of the tubular print medium in a restriction direction including a component in a first direction that intersects a transport direction of the tubular print medium in the medium transport path and the insertion direction of the head insertion hole.

### BRIEF DESCRIPTION OF THE DRAWINGS

FIG. 1 is a perspective view of a printing apparatus and an ink ribbon cartridge according to a first embodiment.

FIG. 2 is a top view of the printing apparatus according to the first embodiment.

FIG. 3 is a perspective view of the ink ribbon cartridge according to the first embodiment.

FIG. 4 is a top view of the ink ribbon cartridge according to the first embodiment.

FIG. 5 is a perspective view of the ink ribbon cartridge according to the first embodiment.

FIG. 6 is a perspective view of the ink ribbon cartridge according to the first embodiment.

FIG. 7 is a top view of the ink ribbon cartridge according to the first embodiment.

FIG. 8 is a cross-sectional view of the ink ribbon cartridge according to the first embodiment.

FIG. 9 is a cross-sectional view of the ink ribbon cartridge according to the first embodiment.

FIG. 10 is a cross-sectional view of the ink ribbon cartridge according to the first embodiment.

### DESCRIPTION OF EMBODIMENTS

### First Embodiment

Hereinafter, an embodiment of an ink ribbon cartridge which can be mounted on a printing apparatus will be described with reference to the drawings. In the following description, in a case where the ink ribbon cartridge is mounted on the printing apparatus in a state where the printing apparatus is installed on a horizontal surface, an axis intersecting the horizontal surface is referred to as a Z-axis, an axis intersecting the Z-axis is referred to as an X-axis, and an axis intersecting the X-axis and the Z-axis is referred to as a Y-axis. One direction along the X-axis is referred to as a first widthwise direction X1, and the other direction along the X-axis is referred to as a second widthwise direction X2. One direction along the Y-axis is referred to as a front side Y1, and the other direction along the Y-axis is referred to as a rear side Y2. An upward direction along the Z-axis is referred to as an upper side Z1, and a downward direction along the Z-axis is referred to as a lower side Z2. A plan view seen from a direction along the Z-axis is simply referred to as a top view.

### Configuration of Printing Apparatus 100

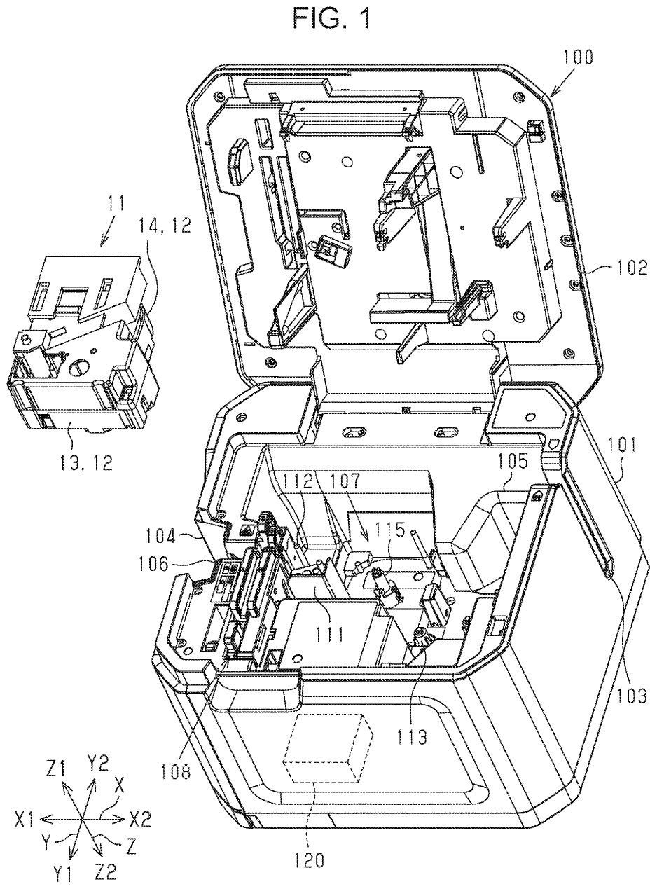

As illustrated in FIG. 1, a printing apparatus 100 is configured to perform printing on a print medium. An ink ribbon cartridge 11 can be mounted on the printing apparatus 100. The printing apparatus 100 is configured to perform printing on a print medium in a state where the ink ribbon cartridge 11 is mounted. The printing apparatus 100 may be configured to perform printing on a print medium which can be introduced from the outside of the printing apparatus 100 and the ink ribbon cartridge 11 in a state where the ink ribbon cartridge 11 is mounted. The print medium may, for example, be a tubular print medium. The tubular print medium may, for example, be a tube.

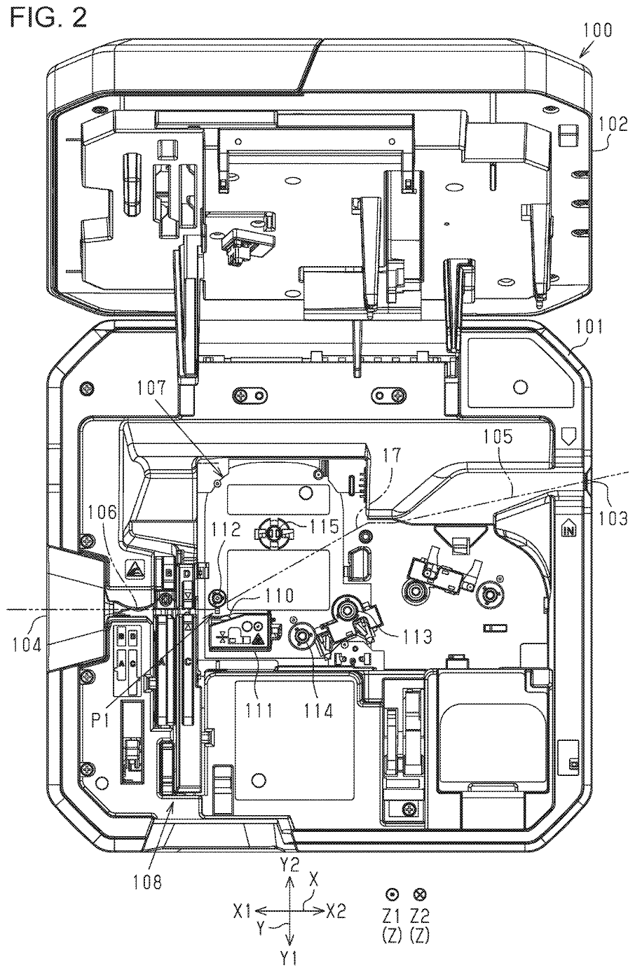

As illustrated in FIG. 2, the printing apparatus 100 includes an apparatus case 101 and an apparatus cover 102. The apparatus case 101 is configured to house various members of the printing apparatus 100. The apparatus case 101 may have a substantially rectangular parallelepiped shape.

The apparatus cover 102 can be opened and closed with respect to the apparatus case 101. The apparatus cover 102 may be rotatably attached to an end portion on the rear side Y2 of the apparatus case 101. The apparatus cover 102 covers the apparatus case 101 from the upper side Z1. The apparatus cover 102 covers the inside of the apparatus case 101. The apparatus cover 102 covers the inside of the apparatus case 101 in a state where the ink ribbon cartridge 11 is mounted.

The apparatus case 101 includes an apparatus side introduction port 103, an apparatus side discharge port 104, an apparatus side introduction path 105, an apparatus side discharge path 106, and a cartridge mounting portion 107. That is, the printing apparatus 100 includes the apparatus side introduction port 103, the apparatus side discharge port 104, the apparatus side introduction path 105, the apparatus side discharge path 106, and the cartridge mounting portion 107.

The apparatus side introduction port 103 may be provided on the side of the apparatus case 101 in the second widthwise direction X2. The apparatus side introduction port 103 may have a shape extending along the Z-axis. The apparatus side introduction port 103 may be a cutout that is open on the upper side Z1. The apparatus side introduction port 103 is a portion for introducing a print medium from the outside of the printing apparatus 100 to the inside of the printing apparatus 100.

The apparatus side discharge port 104 may be provided on the side of the apparatus case 101 in the first widthwise direction X1. The apparatus side discharge port 104 may have a shape extending along the Z-axis. The apparatus side discharge port 104 may be a cutout that is open on the upper side Z1. The apparatus side discharge port 104 is a portion for discharging the print medium from the inside of the printing apparatus 100 to the outside of the printing apparatus 100.

The apparatus side introduction path 105 is provided between the apparatus side introduction port 103 and the cartridge mounting portion 107. The apparatus side introduction path 105 is a path for transporting the print medium introduced from the apparatus side introduction port 103 to the cartridge mounting portion 107 between the apparatus side introduction port 103 and the cartridge mounting portion 107. The apparatus side introduction path 105 may be a recessed portion that is open on the upper side Z1.

The apparatus side discharge path 106 is provided between the cartridge mounting portion 107 and the apparatus side discharge port 104. The apparatus side discharge path 106 is a path for discharging the print medium transported from the cartridge mounting portion 107 from the apparatus side discharge port 104 between the cartridge mounting portion 107 and the apparatus side discharge port 104. The apparatus side discharge path 106 may be a recessed portion that is open on the upper side Z1.

The cartridge mounting portion 107 is a recessed portion that is open on the upper side Z1. The cartridge mounting portion 107 is connected to the apparatus side introduction path 105 on the side in the second widthwise direction X2. The cartridge mounting portion 107 is connected to the apparatus side discharge path 106 on the side in the first widthwise direction X1.

The ink ribbon cartridge 11 can be attached to and detached from the cartridge mounting portion 107 from the upper side Z1. The cartridge mounting portion 107 is configured to house the mounted ink ribbon cartridge 11.

The ink ribbon cartridge 11 in which a print medium has been introduced can be attached to and detached from the cartridge mounting portion 107. In such a case, the print medium introduced into the ink ribbon cartridge 11 can be inserted into the apparatus side introduction port 103 and the apparatus side introduction path 105 from the upper side Z1.

The printing apparatus 100 includes a head 110 and a head cover 111. The head 110 and the head cover 111 are provided in the apparatus case 101. The head 110 and the head cover 111 are provided in the cartridge mounting portion 107.

The head 110 is configured to perform printing on a print medium. The head 110 may be a thermal head that performs printing on a print medium using a heating element. The head 110 is provided at a printing position P1. The printing position P1 is a position at which printing is performed on the print medium by the head 110. The printing position P1 is a position along a medium transport path 17 described later. The head cover 111 partially covers the head 110.

The printing apparatus 100 includes a platen shaft 112. The platen shaft 112 is provided in the apparatus case 101. The platen shaft 112 is provided in the cartridge mounting portion 107. The platen shaft 112 is provided so as to project from the bottom surface of the cartridge mounting portion 107 in the direction of the upper side Z1. The platen shaft 112 is a shaft for transmitting power to a platen roller 22 of the ink ribbon cartridge 11 described later.

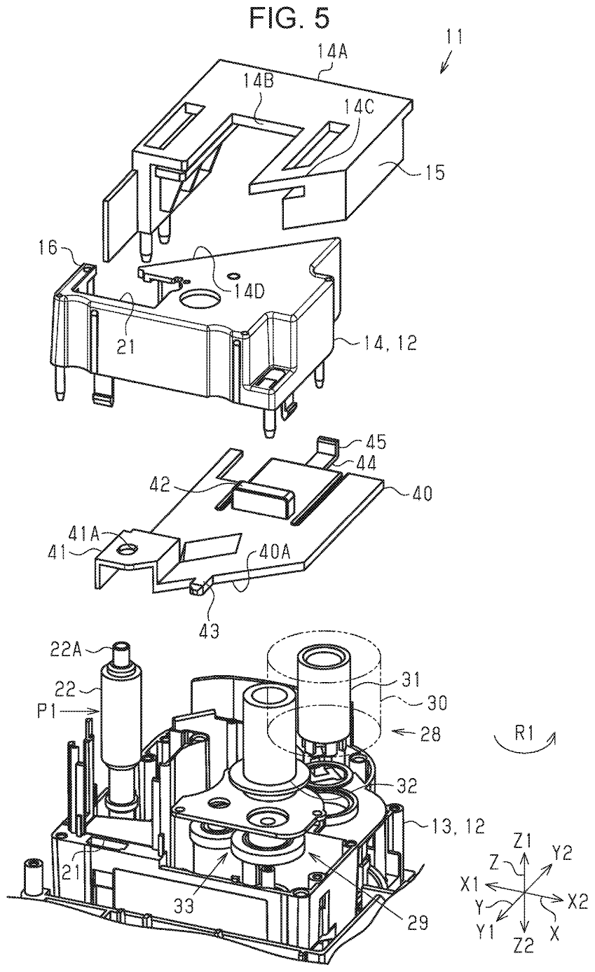

The printing apparatus 100 includes a paying-out shaft 113. The paying-out shaft 113 is provided in the apparatus case 101. The paying-out shaft 113 is provided in the cartridge mounting portion 107. The paying-out shaft 113 is provided so as to project from the bottom surface of the cartridge mounting portion 107 in the direction of the upper side Z1. The paying-out shaft 113 is a shaft for paying out an ink ribbon 30, illustrated in FIG. 5, housed in the ink ribbon cartridge 11. That is, the paying-out shaft 113 is a shaft that pays out the ink ribbon 30.

The printing apparatus 100 includes a winding shaft 114. The winding shaft 114 is provided in the apparatus case 101. The winding shaft 114 is provided in the cartridge mounting portion 107. The winding shaft 114 is provided so as to project from the bottom surface of the cartridge mounting portion 107 in the direction of the upper side Z1. The winding shaft 114 is a shaft that transmits power for taking up the ink ribbon 30 housed in the ink ribbon cartridge 11. That is, the winding shaft 114 is a shaft that takes up the ink ribbon 30.

The printing apparatus 100 includes a projecting portion 115. The projecting portion 115 is provided in the apparatus case 101. The projecting portion 115 is provided in the cartridge mounting portion 107. The projecting portion 115 is provided so as to project in the direction of the upper side Z1. The projecting portion 115 may be provided so as to project from the bottom surface of the cartridge mounting portion 107 in the direction of the upper side Z1.

When the apparatus cover 102 is closed in a state where the ink ribbon cartridge 11 is mounted on the cartridge mounting portion 107, the head 110 is moved toward the platen roller 22 by a head movement mechanism (not illustrated). As a result, the print medium and the ink ribbon 30 are pinched between the head 110 and the platen roller 22.

When the platen shaft 112 and the winding shaft 114 rotate in this state, the print medium and the ink ribbon 30 are transported. At this time, the head 110 generates heat based on print data, so that the ink of the ink ribbon 30 is transferred to the print medium. Thus, printing is performed on the print medium.

In the present embodiment, the ink ribbon cartridge 11 is configured to pay out the ink ribbon 30 by taking up the ink ribbon 30 in response to the power from the winding shaft 114 without receiving power from the paying-out shaft 113, but is not limited thereto.

The printing apparatus 100 may include a cutter mechanism 108. The cutter mechanism 108 is provided in the apparatus case 101. The cutter mechanism 108 is provided downstream of the printing position P1 in a transport direction in which the print medium is transported. The cutter mechanism 108 may be provided in the apparatus side discharge path 106. The cutter mechanism 108 is configured to cut the print medium after printing.

As illustrated in FIG. 1, the printing apparatus 100 includes a control unit 120. The control unit 120 integrally controls the printing apparatus 100. The control unit 120 controls various operations executed by the printing apparatus 100. The control unit 120 may be configured as a circuit including (α) one or more processors that execute various processes in accordance with a computer program, (β) one or more dedicated hardware circuits that execute at least some of the various processes, or (γ) a combination thereof. A hardware circuit is, for example, an application-specific integrated circuit. The processor includes a CPU and a memory such as a RAM and a ROM, and the memory stores program codes or instructions configured to cause the CPU to execute the processes. A memory, that is, a computer-readable medium includes any readable medium accessible by a general-purpose or dedicated computer.

The control unit 120 can control the head 110. The control unit 120 can control a driving unit (not illustrated) that drives each of the platen shaft 112, the paying-out shaft 113, the winding shaft 114, and the projecting portion 115. The control unit 120 can control the cutter mechanism 108.

In the present embodiment, the printing apparatus 100 may be configured such that both the ink ribbon cartridge 11 and a tape cartridge (not illustrated) can be used. In this way, the printing apparatus 100 may be configured such that the ink ribbon cartridge 11 and the tape cartridge (not illustrated) can be selectively mounted on the cartridge mounting portion 107.

The tape cartridge is a cartridge that houses a print tape roll. The print tape roll is a rolled tape serving as a print medium. The projecting portion 115 may be configured to be inserted into the rotation center of the print tape roll via an insertion hole (not illustrated) in the ink ribbon cartridge 11 when the tape cartridge (not illustrated) is mounted on the cartridge mounting portion 107. When the tape cartridge (not illustrated) is mounted on the cartridge mounting portion 107, the projecting portion 115 may transmit a driving force for rotating the print tape roll.

### Configuration of Ink Ribbon Cartridge 11

The ink ribbon cartridge 11 can be mounted on the printing apparatus 100. The ink ribbon cartridge 11 can be mounted on the cartridge mounting portion 107. The ink ribbon cartridge 11 is mounted onto the printing apparatus 100 in the direction of the lower side Z2. The ink ribbon cartridge 11 is removed from the printing apparatus 100 in the direction of the upper side Z1. Thus, the lower side Z2 corresponds to an example of a mounting direction. The upper side Z1 corresponds to an example of a detachment direction which is the direction opposite to the mounting direction.

As illustrated in FIG. 5, the ink ribbon cartridge 11 houses the ink ribbon 30. The ink ribbon cartridge 11 may be configured to perform printing on a print medium that can be introduced from the outside of the ink ribbon cartridge 11.

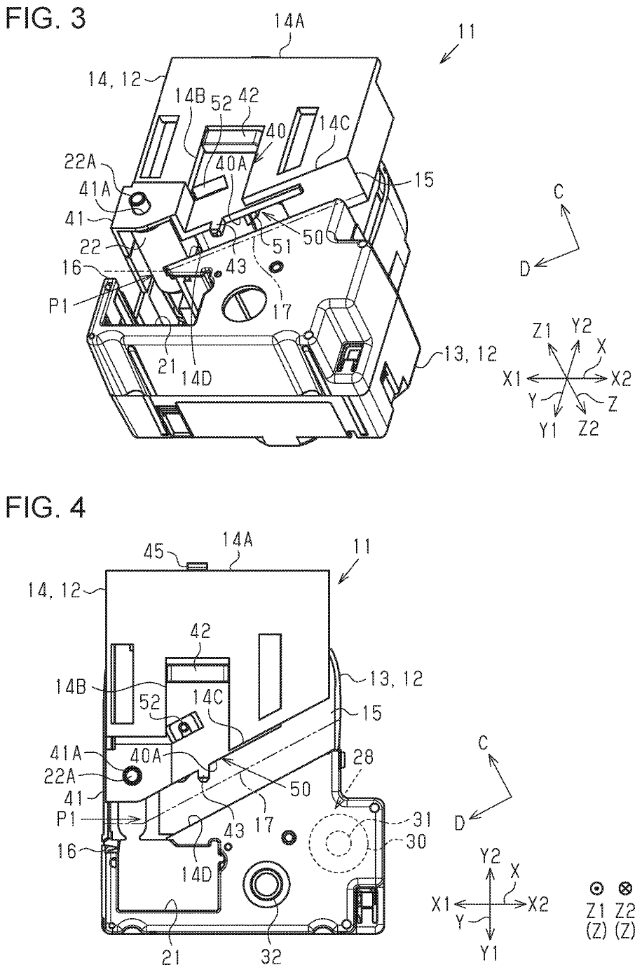

As illustrated in FIGS. 3 and 4, the ink ribbon cartridge 11 includes a cartridge case 12. The cartridge case 12 is the exterior of the ink ribbon cartridge 11. The cartridge case 12 houses various components of the ink ribbon cartridge 11. The cartridge case 12 houses the ink ribbon 30.

The cartridge case 12 includes a first case 13 and a second case 14. When the ink ribbon cartridge 11 is mounted on the printing apparatus 100, the second case 14 is positioned on the upper side Z1 of the first case 13. The second case 14 is configured to cover the first case 13 from the upper side Z1. In this way, the first case 13 is positioned on the lower side Z2, and the second case 14 is positioned on the upper side Z1.

The cartridge case 12 includes an introduction port 15 and a discharge port 16. The introduction port 15 may be provided on the side of the cartridge case 12 in the second widthwise direction X2. The introduction port 15 may have a shape extending along the Z-axis. The introduction port 15 may be a cutout that is open on the upper side Z1. The introduction port 15 is provided in the second case 14, but may be provided in the first case 13, or may be provided to extend across the first case 13 and the second case 14. The introduction port 15 is a portion for introducing a print medium from the outside of the cartridge case 12 to the inside of the cartridge case 12.

The discharge port 16 may be provided on the side of the cartridge case 12 in the first widthwise direction X1. The discharge port 16 may have a shape extending along the Z-axis. The discharge port 16 may be a cutout that is open on the upper side Z1. The discharge port 16 is provided in the second case 14, but may be provided in the first case 13, or may be provided to extend across the first case 13 and the second case 14. The discharge port 16 is a portion for discharging the print medium from the inside of the cartridge case 12.

The cartridge case 12 includes the medium transport path 17. The medium transport path 17 is provided in the second case 14, but may be provided in the first case 13, or may be provided to extend across the first case 13 and the second case 14.

The medium transport path 17 is connected to the introduction port 15 and the discharge port 16 in the cartridge case 12. The medium transport path 17 is a path along which the print medium is transported. The medium transport path 17 is a path for transporting the print medium introduced to the inside of the cartridge case 12 through the introduction port 15.

The medium transport path 17 is a path that connects at least the introduction port 15 and the printing position P1. The medium transport path 17 is a path along which the print medium introduced from the introduction port 15 is transported to the printing position P1. The medium transport path 17 is a path that connects the printing position P1 and the discharge port 16. The medium transport path 17 is a path for transporting the print medium printed at the printing position P1 so that the print medium is discharged from the discharge port 16.

The cartridge case 12 includes a head insertion hole 21. That is, the ink ribbon cartridge 11 includes the head insertion hole 21. The head insertion hole 21 is provided so as to extend through the cartridge case 12 along the Z-axis. Specifically, the head insertion hole 21 is provided in the first case 13 and the second case 14. The head insertion hole 21 is provided so as to extend through the first case 13 and the second case 14.

In a state where the ink ribbon cartridge 11 is mounted on the cartridge mounting portion 107, the head 110 and the head cover 111 are inserted into the head insertion hole 21 in the direction of the upper side Z1. That is, the head 110 can be inserted into the head insertion hole 21 at the printing position P1 in the cartridge case 12. Thus, the upper side Z1 corresponds to an example of an insertion direction in which the head 110 is inserted.

The second case 14 includes a side wall 14A. The side wall 14A is a portion facing the rear side Y2. The side wall 14A is included in a portion of the cartridge case 12 facing the rear side Y2.

The second case 14 includes a guide slit 14B. The guide slit 14B is provided along the Y-axis. The guide slit 14B is provided so as to be open on the front side Y1. The guide slit 14B is provided so as to be open to the medium transport path 17 on the front side Y1. As will be described in detail later, the guide slit 14B guides the movement of a movable portion 40 by being in contact with an operation projection 42 in the X-axis direction. That is, the guide slit 14B is provided along the movement direction of the movable portion 40.

The second case 14 includes an opening portion 14C. The opening portion 14C is provided in the upper surface of the second case 14. The opening portion 14C is positioned on the upper side Z1 of the medium transport path 17. The opening portion 14C is open on the upper side Z1 so that the medium transport path 17 is exposed.

The second case 14 includes a second inner wall 14D. The second inner wall 14D is configured to define the medium transport path 17. That is, the second inner wall 14D is provided in the medium transport path 17. That is, the medium transport path 17 includes the second inner wall 14D. The second inner wall 14D is a surface facing an intersecting direction C in the second case 14. The intersecting direction C is a direction that intersects a transport direction D along the medium transport path 17 and the direction of the lower side Z2 along the Z-axis, and that faces the rear side Y2. The second inner wall 14D is parallel to the transport direction D of the print medium and the direction of the lower side Z2. The intersecting direction C corresponds to an example of a first direction.

As illustrated in FIG. 5, the ink ribbon cartridge 11 may include the platen roller 22. The platen roller 22 is provided in the cartridge case 12. The platen roller 22 is configured to extend along the Z-axis. The platen roller 22 is provided in the second case 14 along the Z-axis, but may be provided so as to extend across the first case 13 and the second case 14.

In a state where the ink ribbon cartridge 11 is mounted on the cartridge mounting portion 107, the platen roller 22 is provided at a position facing the head 110. In a state where the ink ribbon cartridge 11 is mounted on the cartridge mounting portion 107, the platen roller 22 is configured to pinch the print medium and the ink ribbon 30 between the platen roller 22 and the head 110 at the printing position P1.

In a state where the ink ribbon cartridge 11 is mounted on the cartridge mounting portion 107, power is transmitted to the platen roller 22 from the platen shaft 112. The platen roller 22 is connected to the platen shaft 112 via a platen shaft insertion hole (not illustrated) in the first case 13. The print medium and the ink ribbon 30 are transported along the medium transport path 17 by the rotation of the platen roller 22 while being pinched between the platen roller 22 and the head 110.

In the present embodiment, the print medium has a size equal to or less than half of the length of the ink ribbon cartridge 11 along the Z-axis, but is not limited thereto. The print medium is transported along the medium transport path 17 provided in the second case 14 inside the ink ribbon cartridge 11, but is not limited thereto.

The cartridge case 12 includes an ink ribbon housing area 28. The ink ribbon housing area 28 is provided on the second case 14 side in the direction along the Z-axis. The ink ribbon housing area 28 is provided in the second case 14 along the Z-axis, but may be provided so as to extend across the second case 14 and the first case 13.

The ink ribbon housing area 28 is an area in which the ink ribbon 30 can be housed in the cartridge case 12. The ink ribbon housing area 28 houses a paying-out core 31. The ink ribbon housing area 28 houses a paying-out roll. The paying-out roll is a roll assembly including the wound ink ribbon 30 to be fed to the printing position P1. The paying-out roll includes the paying-out core 31. The paying-out roll may include the ink ribbon 30 wound around the paying-out core 31.

The ink ribbon housing area 28 houses a winding core 32. The ink ribbon housing area 28 houses a winding roll. The winding roll is a roll assembly including the wound ink ribbon 30 transported from the printing position P1. The winding roll includes the winding core 32. The winding roll may include the ink ribbon 30 wound around the winding core 32.

The ink ribbon cartridge 11 includes a gear train housing area 29 and a gear train 33. The gear train housing area 29 is provided in the cartridge case 12. The gear train housing area 29 is an area that houses the gear train 33. That is, the gear train 33 is housed in the cartridge case 12.

The gear train housing area 29 is provided on the first case 13 side in the direction along the Z-axis. The gear train housing area 29 is provided in the first case 13 in the direction along the Z-axis, but may be provided so as to extend across the first case 13 and the second case 14. The gear train housing area 29 is provided so as to overlap the ink ribbon housing area 28 in a top view.

When the ink ribbon cartridge 11 is mounted on the cartridge mounting portion 107, the gear train 33 is configured to transmit the power of the winding shaft 114 to the winding roll. The gear train 33 is connected to the winding shaft 114 via a winding shaft insertion hole (not illustrated) in the first case 13.

The gear train 33 may be configured to rotate the winding roll in a first circumferential direction R1 when the winding shaft 114 rotates in the first circumferential direction R1. The gear train 33 may be configured such that the ratio between the rotational speed of the winding shaft 114 and the rotational speed of the winding roll is 1:1. The gear train 33 may include an odd number of gears and may include three gears.

As described above, in a state where the ink ribbon cartridge 11 is mounted on the cartridge mounting portion 107, the rotational axis of the winding core 32 is provided to be parallel to the rotational axis of the winding shaft 114 and is different from the rotational axis of the winding shaft 114.

### Configuration of Movable Portion 40

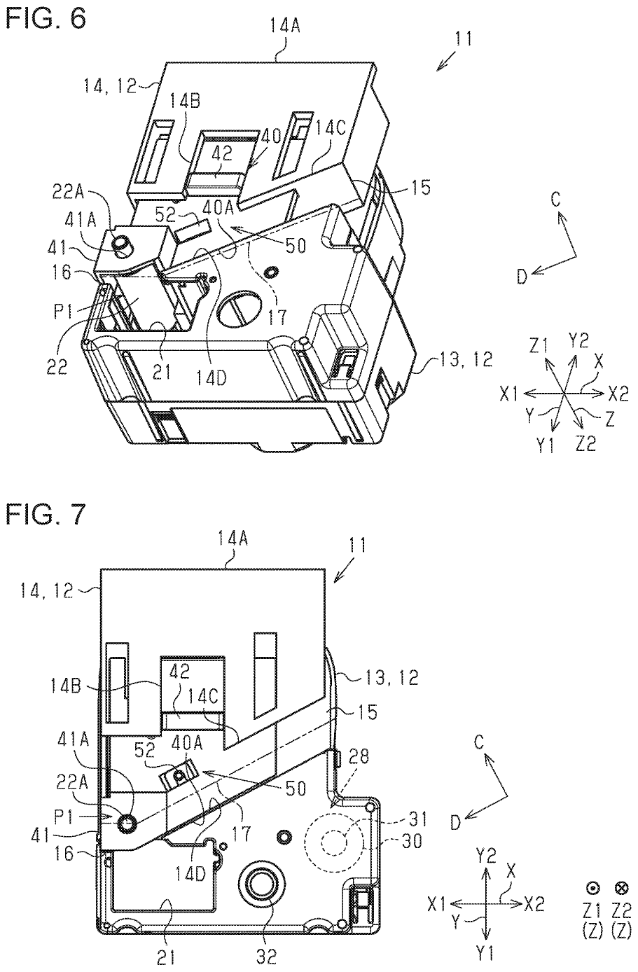

The ink ribbon cartridge 11 includes the movable portion 40. The movable portion 40 is attached to the second case 14. The movable portion 40 may include a plate-shaped movable member. The movable portion 40 is configured to open and close the medium transport path 17 from the upper side Z1. The movable portion 40 is movable along the Y-axis between an open position illustrated in FIGS. 3 and 4 and a closed position illustrated in FIGS. 6 and 7.

As illustrated in FIGS. 3 and 4, the open position is a position at which the movable portion 40 does not cover the opening portion 14C. The open position is a position at which the movable portion 40 opens the medium transport path 17. As illustrated in FIGS. 6 and 7, the closed position is a position at which the movable portion 40 covers the opening portion 14C. The closed position is a position at which the movable portion 40 closes the medium transport path 17.

As illustrated in FIGS. 3, 4, 6, and 7, when the movable portion 40 moves to the front side Y1, it moves from the open position to the closed position. When the movable portion 40 moves to the rear side Y2, it moves from the closed position to the open position. The front side Y1 corresponds to an example of a first movement direction. The rear side Y2 corresponds to an example of a second movement direction.

As illustrated in FIG. 5, the movable portion 40 includes a first inner wall 40A. The first inner wall 40A serves as at least a part of the bottom surface of the movable portion 40. The first inner wall 40A is configured to define the medium transport path 17 from the upper side Z1 when the movable portion 40 is positioned at the closed position. That is, the first inner wall 40A is provided over the medium transport path 17. The medium transport path 17 includes the first inner wall 40A. The first inner wall 40A is provided on the bottom surface of the movable portion 40. The first inner wall 40A is a surface perpendicular to the Z-axis.

The movable portion 40 may include a platen roller holding portion 41. The platen roller holding portion 41 is provided on the first widthwise direction X1 side of the movable portion 40. The platen roller holding portion 41 is provided on the front side Y1 side of the movable portion 40. The platen roller holding portion 41 may be configured to project in the direction of the front side Y1.

The platen roller holding portion 41 may include a through hole 41A. A rotation shaft end portion 22A of the platen roller 22 passes through the through hole 41A. Thus, the platen roller holding portion 41 is configured to rotatably hold the platen roller 22.

The movable portion 40 moves the platen roller 22 when it opens and closes the medium transport path 17. In particular, when the movable portion 40 moves to the closed position, it moves the platen roller 22 to a pinching position. The pinching position is a position at which the platen roller 22, together with the head 110, pinches the print medium. The pinching position may be a position at which the platen roller 22 is disposed along the Z-axis.

When the movable portion 40 moves to the open position, it moves the platen roller 22 to a separated position. The separated position is a position away from the pinching position with respect to the medium transport path 17. The separated position is a position at which the platen roller 22 does not pinch the print medium. The separated position may be a position at which the platen roller 22 is inclined with respect to the Z-axis.

The movable portion 40 may include the operation projection 42. The operation projection 42 is provided on the upper surface of the movable portion 40. The operation projection 42 is configured to project in the direction of the upper side Z1 from the upper surface of the movable portion 40 in the movable portion 40.

The operation projection 42 is exposed from the second case 14. The operation projection 42 is exposed from the second case 14 through the guide slit 14B. The operation projection 42 is a portion for operating the movement of the movable portion 40. The operation projection 42 may be a finger hooking projection on which a user's finger can be hooked. The operation projection 42 is guided along the guide slit 14B in a state of being exposed from the second case 14 when the movable portion 40 moves along the Y-axis.

The movable portion 40 may include a first engagement portion 43. The first engagement portion 43 is provided on the front side Y1 of the movable portion 40. When the movable portion 40 is positioned at the closed position, the first engagement portion 43 engages with the cartridge case 12 on the front side Y1. When the movable portion 40 is positioned at the closed position, the first engagement portion 43 engages with the cartridge case 12 on the upper side Z1 of the medium transport path 17.

The movable portion 40 may include a flexible portion 44 and a second engagement portion 45. The second engagement portion 45 corresponds to an example of an engagement portion. The flexible portion 44 is provided on the rear side Y2 of the movable portion 40. The flexible portion 44 is configured to extend in the direction of the rear side Y2. The flexible portion 44 is configured to bend in response to a force in the direction of the lower side Z2.

The second engagement portion 45 is provided on the rear side Y2 of the movable portion 40. The second engagement portion 45 is provided at the distal end portion of the flexible portion 44. The second engagement portion 45 is configured to extend in the direction of the upper side Z1 at the distal end portion of the flexible portion 44.

As illustrated in FIG. 9, when the movable portion 40 is moved from the open position to the front side Y1, the second engagement portion 45 comes into contact with a projection 14E of the second case 14. The projection 14E is configured to project to the lower side Z2. When the second engagement portion 45 and the projection 14E come into contact with each other, the flexible portion 44 bends such that the second engagement portion 45 moves to the lower side Z2, and the second engagement portion 45 moves downward to pass over the projection 14E and is positioned on the front side Y1 of the projection 14E. As a result, the movable portion 40 moves from the open position to the closed position. The second engagement portion 45 engages with the projection 14E, but is not limited to engaging with the projection 14E. When the movable portion 40 moves from the open position to the closed position, an operation with click feeling can be achieved.

As illustrated in FIG. 10, when the medium transport path 17 is closed by the movable portion 40 moving from the open position to the closed position, the second engagement portion 45 does not project to the outside from the side wall 14A on the rear side Y2 of the second case 14. In this case, the second engagement portion 45 is configured to engage with the second case 14.

When the movable portion 40 moves from the closed position to the rear side Y2, the second engagement portion 45 comes into contact with the projection 14E. As a result, the flexible portion 44 bends so that the second engagement portion 45 moves to the lower side Z2, and the second engagement portion 45 moves downward to pass over the projection 14E and is positioned on the rear side Y2 of the projection 14E. Thus, the movable portion 40 moves from the closed position to the open position. In this case, the movable portion 40 may be operated so as to move to the rear side Y2 in a state where the operation projection 42 is pushed down from the upper side Z1.

When the movable portion 40 moves from the closed position to the open position to open the medium transport path 17, the second engagement portion 45 is positioned so as to projection outward from the side wall 14A of the rear side Y2 of the second case 14. That is, when the movable portion 40 moves from the closed position to the open position, the second engagement portion 45 is positioned so as to project outward from the side wall 14A on the rear side Y2 of the cartridge case 12.

### Configuration of Restricting Portion 50

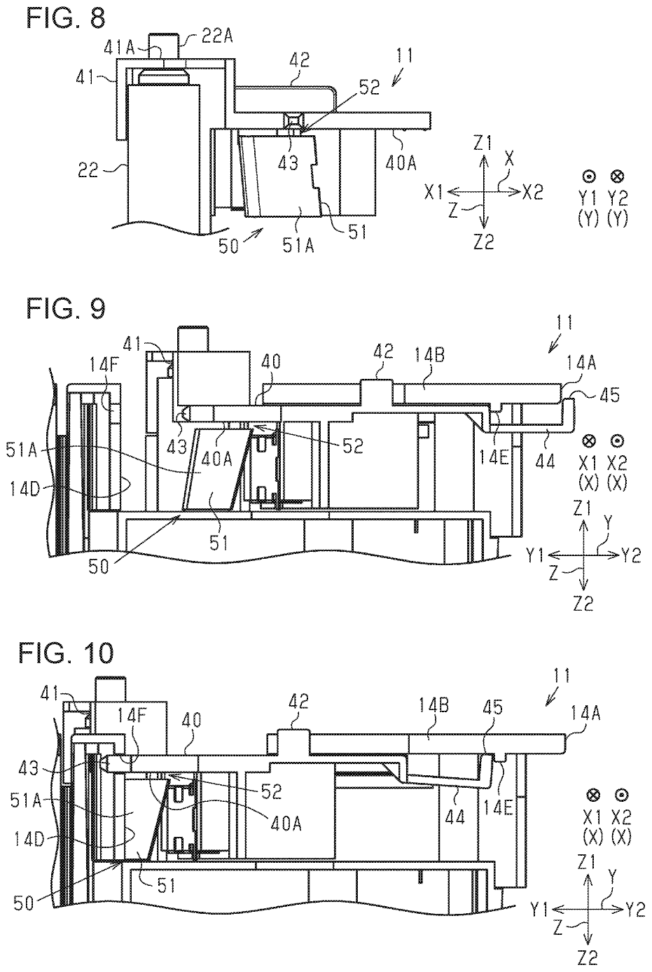

As illustrated in FIGS. 8 to 10, the ink ribbon cartridge 11 includes a restricting portion 50. The restricting portion 50 may be provided in the movable portion 40. That is, the movable portion 40 may include the restricting portion 50.

The restricting portion 50 may be provided at a position along the medium transport path 17. The restricting portion 50 may be provided upstream of the printing position P1 among the positions along the medium transport path 17. The restricting portion 50 may be provided upstream of the head insertion hole 21 among the positions along the medium transport path 17.

When the movable portion 40 is positioned at the open position, the restricting portion 50 is at a position away from the medium transport path 17. When the movable portion 40 is positioned at the closed position, the restricting portion 50 is at a position in the medium transport path 17. In this manner, the restricting portion 50 is movable between the position away from the medium transport path 17 and the position in the medium transport path 17 in conjunction with the movable portion 40.

When the movable portion 40 is positioned at the closed position, the restricting portion 50 is configured to restrict the movement of the print medium in a restriction direction in the medium transport path 17. The restriction direction includes a component in the intersecting direction C. The restriction direction includes a component in the direction of the lower side Z2. The restriction direction includes a component in the upstream direction of the medium transport path 17.

The restricting portion 50 includes a pressing portion 51 and a holding portion 52 that holds the pressing portion 51. The pressing portion 51 is held on the bottom surface of the movable portion 40 by the holding portion 52. The pressing portion 51 may be an elastic member that restricts the movement of the print medium. The pressing portion 51 may be a flat spring.

The pressing portion 51 includes a pressing surface 51A. The pressing surface 51A is a surface that presses the print medium in the medium transport path 17. The pressing surface 51A is a surface that restricts the movement of the print medium in the restriction direction in the medium transport path 17.

The pressing surface 51A is a surface facing the intersecting direction C. The pressing surface 51A may be a surface inclined in the downstream direction of the medium transport path 17 with respect to the intersecting direction C. The pressing surface 51A may be a surface inclined in the direction of the upper side Z1.

In this manner, the pressing portion 51 is configured to restrict the movement of the print medium in the restriction direction in the medium transport path 17. The pressing portion 51 is configured to be inclined with respect to the first inner wall 40A, the second inner wall 14D, and the transport direction D of the print medium.

### Operation of Ink Ribbon Cartridge 11

The ink ribbon cartridge 11 illustrated in FIG. 9 is removed from the printing apparatus 100. In the ink ribbon cartridge 11, the movable portion 40 is positioned at the open position. The medium transport path 17 is open on the upper side Z1. The platen roller 22 is positioned at the separated position.

In this way, the print medium can be set in the medium transport path 17 from the upper side Z1, and is not pressed by the platen roller 22 around the platen roller 22. As a result, the print medium can be easily set in the ink ribbon cartridge 11.

As illustrated in FIG. 10, in the ink ribbon cartridge 11, when the movable portion 40 moves from the open position to the closed position, the medium transport path 17 is closed on the upper side Z1. The platen roller 22 moves from the separated position to the pinching position.

In this state, the pressing portion 51 presses the print medium in a direction opposite to the restriction direction. Specifically, the pressing portion 51 presses the print medium in a direction including a component in the intersecting direction C. The pressing portion 51 presses the print medium in a direction including a component in the direction of the upper side Z1. The pressing portion 51 presses the print medium in a direction including a component in the upstream direction of the medium transport path 17. Accordingly, the pressing portion 51 restricts the movement of the print medium in the restriction direction in the medium transport path 17.

When the movable portion 40 is positioned at the closed position as described above, the first engagement portion 43 engages with an engagement slit 14F provided in the second inner wall 14D. The second engagement portion 45 moves downward to pass over the projection 14E from the rear side Y2 to the front side Y1 and engages with the projection 14E. Accordingly, the movable portion 40 can stably close the medium transport path 17.

### Operation and Effect of First Embodiment

The operation and effect of the first embodiment will be described.

(1) The movable portion 40 opens and closes the medium transport path 17 from the upper side Z1. The restricting portion 50 restricts the movement of the print medium in a restriction direction including components in the transport direction D of the print medium and the intersecting direction C in the medium transport path 17. According to this configuration, the medium transport path 17 can be opened and closed from the upper side Z1, and the movement of the print medium in the restriction direction can be restricted. In this way, it is possible to set the print medium in the medium transport path 17 from the upper side Z1 without performing an operation of inserting the print medium into the medium transport path 17 from the introduction port 15. Thus, operability can be improved. In addition, the print medium can be set at an appropriate position. Therefore, convenience can be improved.

(2) The restriction direction includes a component in the intersecting direction C and a component in the direction of the upper side Z1. According to this configuration, it is possible to restrict the movement of the print medium in the restriction direction including not only a component in the intersecting direction C intersecting the medium transport path 17 but also a component in the direction of the upper side Z1. Accordingly, it is possible to set the print medium at an appropriate position. Therefore, convenience can be improved.

(3) The pressing portion 51 is configured to be inclined with respect to the first inner wall 40A perpendicular to the direction of the upper side Z1, the second inner wall 14D parallel to the transport direction D and the direction of the upper side Z1, and the transport direction D. According to this configuration, it is possible to restrict the movement of the print medium relative to the first inner wall 40A, the second inner wall 14D, and the transport direction D. Accordingly, it is possible to set the print medium at an appropriate position. Therefore, convenience can be improved.

(4) The movable portion 40 includes the platen roller holding portion 41 that rotatably holds the platen roller 22. The movable portion 40 moves the platen roller 22 when it opens and closes the medium transport path 17. According to this configuration, it is possible to move the platen roller 22 along with the opening and closing of the medium transport path 17 by the movable portion 40. Thus, operability can be improved. Therefore, convenience can be improved.

(5) The movable portion 40 is provided with the operation projection 42 projecting to the upper side Z1. The operation projection 42 is exposed from the second case 14. According to this configuration, the movable portion 40 can be moved by the operation of the operation projection 42 exposed from the second case 14. Thus, operability can be improved. Therefore, convenience can be improved.

(6) When the movable portion 40 moves, the operation projection 42 is guided along the guide slit 14B in a state of being exposed from the second case 14. According to this configuration, the movable portion 40 can be operated smoothly. Thus, operability can be improved. Therefore, convenience can be improved.

(7) The movable portion 40 includes the second engagement portion 45. The second engagement portion 45 projects outward from the side wall 14A when the movable portion 40 opens the medium transport path 17. The second engagement portion 45 is configured to engage with the second case 14 without projecting outward from the side wall 14A when the movable portion 40 closes the medium transport path 17. According to this configuration, when the movable portion 40 closes the medium transport path 17, the second engagement portion 45 engages with the second case 14, and thus it is possible to stably close the medium transport path 17. In addition, since the second engagement portion 45 does not project outward from the side wall 14A, unintended contact of the second engagement portion 45 can be suppressed when the ink ribbon cartridge 11 is handled. Thus, operability can be improved. Therefore, convenience can be improved.

### Modifications

The present embodiment can be modified and implemented as follows. The present embodiment and the following modifications can be implemented in combination with each other unless a technical contradiction occurs.
The ink ribbon housing area 28 may be provided to extend across the first case 13 and the second case 14. The gear train housing area 29 may be provided to extend across the first case 13 and the second case 14 as long as the gear train 33 is disposed at a position where the gear train 33 does not interfere with the winding core 32 in the Z-axis direction.
In the gear train 33, the ratio between the rotational speed of the winding shaft 114 and the rotational speed of the winding core 32 is not limited to 1:1. That is, the gear train 33 may be configured such that the rotational speed of the winding core 32 is lower than the rotational speed of the winding shaft 114. The gear train 33 may be configured such that the rotational speed of the winding core 32 is higher than the rotational speed of the winding shaft 114.
The gear train 33 may rotate the winding shaft 114 and the winding core 32 in the same direction which is opposite to the first circumferential direction R1. In the gear train 33, the rotational direction of the winding shaft 114 need not necessarily be the same as the rotational direction of the winding core 32.
The gear train 33 may include two or four or more gears. The gear train 33 may include an odd number of gears so that the rotational direction of the winding shaft 114 is the same as the rotational direction of the winding core 32. The plurality of gears included in the gear train 33 may include a gear whose rotational axis is not parallel to those of the others. The ink ribbon cartridge 11 is not limited to including the gear train 33.
The movable portion 40 needs only to close at least a part of the medium transport path 17 at the closed position, or may close the entire medium transport path 17 at the closed position. The movable portion 40 may be configured to open at least a part of the medium transport path 17 at the open position, or may be configured to open the entire medium transport path 17 at the open position.
The restriction direction may be any direction as long as it includes at least a component in the intersecting direction C. The restriction direction is not limited to including a component in the direction of the lower side Z2, and may include a component in the direction of the upper side Z1. The restriction direction is not limited to including a component in the direction opposite to the transport direction D, and may include a component in the transport direction D. In this case, as long as the print medium is pressed toward the second inner wall 14D in the medium transport path 17, the print medium need not be pressed toward the first inner wall 40A.
After the ink ribbon cartridge 11 is mounted on the printing apparatus 100, the print medium may be introduced from the outside to the inside of the ink ribbon cartridge 11 through the introduction port 15 and may be pulled into the medium transport path 17.
The printing apparatus 100 may include the platen roller 22 itself. A configuration in which the ink ribbon cartridge 11 does not include the platen roller 22 and includes a platen roller insertion hole is also possible. The platen roller insertion hole is a hole into which the platen roller 22 can be inserted. When the ink ribbon cartridge 11 is mounted on the cartridge mounting portion 107, the platen roller 22 is inserted into the platen roller insertion hole.
The expression “at least one” used in the present specification means one or more of desired options. As an example, the expression “at least one” used in the present specification means both the case where only one option is selected and the case where two options are selected when the number of options is two. As another example, when the number of options is three or more, the expression “at least one” used in the present specification means the case where only one option is selected and the cases where any combination of two or more options is selected.

### Appendix

Hereinafter, the technical ideas and the operation and effect derived from the above-described embodiment and modifications will be described. The technical ideas and the operation and effect thereof can be combined with each other unless a technical contradiction occurs.

[1] An ink ribbon cartridge configured to be mounted on a printing apparatus that performs printing on a tubular print medium that can be introduced from the outside includes: an ink ribbon housing area that is in a cartridge case and is configured to house an ink ribbon; a head insertion hole through which a head of the printing apparatus can be inserted at a printing position in the cartridge case; an introduction port for introducing a tubular print medium into the cartridge case; a medium transport path that connects at least the introduction port and the printing position, and through which the tubular print medium introduced from the introduction port is transported to the printing position; and a movable portion that opens and closes the medium transport path from a side of an insertion direction in which the head is inserted, and the movable portion includes a restricting portion that restricts movement of the tubular print medium in a restriction direction including a component in a first direction that intersects a transport direction of the tubular print medium in the medium transport path and the insertion direction of the head insertion hole.

According to this configuration, the medium transport path can be opened and closed from the insertion direction side, and the movement of the tubular print medium in the restriction direction can be restricted. Accordingly, it is possible to set the tubular print medium in the medium transport path from the insertion direction side without performing an operation of inserting the tubular print medium into the medium transport path from the introduction port. Thus, operability can be improved. In addition, the tubular print medium can be set at an appropriate position. Therefore, convenience can be improved.

[2] In the ink ribbon cartridge described above, the restriction direction includes a component in the first direction and a component in the insertion direction.

According to this configuration, it is possible to restrict the movement of the tubular print medium in the restriction direction including not only the component in the first direction intersecting the medium transport path but also the component in the insertion direction. As a result, the tubular print medium can be set at an appropriate position. Therefore, convenience can be improved.

[3] In the ink ribbon cartridge described above, the medium transport path includes a first inner wall perpendicular to the insertion direction and a second inner wall parallel to the transport direction and the insertion direction, and the restricting portion includes a pressing portion and a holding portion that holds the pressing portion, and the pressing portion is inclined with respect to the first inner wall, the second inner wall, and the transport direction.

According to this configuration, it is possible to restrict the movement of the tubular print medium in the directions of the first inner wall and the second inner wall and in the transport direction. As a result, the tubular print medium can be set at an appropriate position. Therefore, convenience can be improved.

[4] In the ink ribbon cartridge described above, the cartridge case includes a first case on a side of a direction opposite to the insertion direction and a second case on the side of the insertion direction, the movable portion is attached to the second case, the movable portion includes a platen roller holding portion that rotatably holds a platen roller, and the movable portion moves the platen roller when the movable portion opens and closes the medium transport path.

According to this configuration, the platen roller can be moved in conjunction with the opening and closing of the medium transport path by the movable portion. Thus, operability can be improved. Therefore, convenience can be improved.

[5] In the ink ribbon cartridge described above, the cartridge case includes a first case on a side of the first direction and a second case on the side of the insertion direction, the movable portion is attached to the second case, the movable portion includes an operation projection projecting in the insertion direction, and the operation projection is exposed from the second case.

According to this configuration, the movable portion can be moved by the operation of the operation projection exposed from the second case. Thus, operability can be improved. Therefore, convenience can be improved.

[6] In the ink ribbon cartridge described above, the second case includes a guide slit extending in a movement direction of the movable portion, and the operation projection is guided along the guide slit in a state of being exposed from the second case when the movable portion moves.

According to this configuration, the operation projection is guided along the guide slit in a state of being exposed from the second case when the movable portion moves. Therefore, the movable portion can be operated smoothly. Thus, operability can be improved. Therefore, convenience can be improved.

[7] In the ink ribbon cartridge described above, the cartridge case includes a first case on a side of the first direction and a second case on the side of the insertion direction, the movable portion is attached to the second case, the movable portion includes an engagement portion, and the engagement portion projects outward from a side wall of the second case when the movable portion opens the medium transport path, and engages with the second case without projecting outward from the side wall of the second case when the movable portion closes the medium transport path.

According to this configuration, when the movable portion closes the medium transport path, the engagement portion engages with the second case, and thus it is possible to stably close the medium transport path. In addition, since the engagement portion does not project outward from the side wall of the second case, it is possible to suppress unintended contact of the engagement portion when handling the ink ribbon cartridge. Thus, operability can be improved. Therefore, convenience can be improved.

What is claimed is:

1. An ink ribbon cartridge configured to be mounted on a printing apparatus that performs printing on a tubular print medium that can be introduced from the outside, the ink ribbon cartridge comprising:
an ink ribbon housing area that is in a cartridge case and is configured to house an ink ribbon;
a head insertion hole through which a head of the printing apparatus can be inserted at a printing position in the cartridge case;
an introduction port for introducing a tubular print medium into the cartridge case;
a medium transport path that connects at least the introduction port and the printing position, and through which the tubular print medium introduced from the introduction port is transported to the printing position; and
a movable portion that opens and closes the medium transport path from a side of an insertion direction in which the head is inserted, wherein
the movable portion includes a restricting portion that restricts movement of the tubular print medium in a restriction direction including a component in a first direction that intersects a transport direction of the tubular print medium in the medium transport path and the insertion direction of the head insertion hole.

2. The ink ribbon cartridge according to claim 1, wherein
the restriction direction includes a component in the first direction and a component in the insertion direction.

3. The ink ribbon cartridge according to claim 2, wherein
the medium transport path includes a first inner wall perpendicular to the insertion direction and a second inner wall parallel to the transport direction and the insertion direction, and
the restricting portion includes a pressing portion and a holding portion that holds the pressing portion, and the pressing portion is inclined with respect to the first inner wall, the second inner wall, and the transport direction.

4. The ink ribbon cartridge according to claim 2, wherein
the cartridge case includes a first case on a side of a direction opposite to the insertion direction and a second case on the side of the insertion direction,
the movable portion is attached to the second case,
the movable portion includes a platen roller holding portion that rotatably holds a platen roller, and
the movable portion moves the platen roller when the movable portion opens and closes the medium transport path.

5. The ink ribbon cartridge according to claim 2, wherein
the cartridge case includes a first case on a side of the first direction and a second case on the side of the insertion direction,
the movable portion is attached to the second case,
the movable portion includes an operation projection projecting in the insertion direction, and
the operation projection is exposed from the second case.

6. The ink ribbon cartridge according to claim 5, wherein
the second case includes a guide slit extending in a movement direction of the movable portion, and
the operation projection is guided along the guide slit in a state of being exposed from the second case when the movable portion moves.

7. The ink ribbon cartridge according to claim 2, wherein
the cartridge case includes a first case on a side of the first direction and a second case on the side of the insertion direction,
the movable portion is attached to the second case,
the movable portion includes an engagement portion, and
the engagement portion projects outward from a side wall of the second case when the movable portion opens the medium transport path, and engages with the second case without projecting outward from the side wall of the second case when the movable portion closes the medium transport path.
